(19) United States
(12) Patent Application Publication
(10) Pub. No.: US 2015/0282439 A1
(43) Pub. Date: Oct. 8, 2015

(54) PLANT HOUSING SYSTEM

(71) Applicant: BORNEO EXOTICS (PVT) LTD, Hokandara South (LK)

(72) Inventor: Robert Cantley, Hokandara South (LK)

(21) Appl. No.: 14/440,538

(22) PCT Filed: Oct. 29, 2013
(86) PCT No.: PCT/IB2013/059746

§ 371 Date: May 4, 2015

(30) Foreign Application Priority Data
Nov. 2, 2012 (LK) 16925

(51) Int. Cl. A01G 9/02; A01G 27/02

(52) U.S. Cl. CPC A01G 9/02; A01G 27/02

(57) ABSTRACT

A plant housing in general and more specifically a system and a method for plant housing for plant growth is provided. An object of the invention is to provide an improved plant housing. The present invention attains the above-described objective by a plant housing being provided with means for setting up an environmental gradient comprising at least one aperture, wherein the plant will adapt to the surrounding environment during the time it takes to grow past said aperture. The environmental gradient can be a temperature gradient and/or a humidity gradient.

### CLAIM TO PRIORITY

The present Application for Patent claims benefit of patent application entitled “PLANT HOUSING SYSTEM”, filed in Sri Lanka on 2 Nov. 2012, and bearing number 16925 and hereby expressly incorporated by reference herein.

### BACKGROUND OF THE INVENTION

1. Technical Field

The invention relates to plant housing in general and more specifically a system and a method for plant housing for plant growth.

2. Background Art

Plant growing pots or containers are well known in the art and pots or containers with plastic domes or covers to maintain humidity for the plant are known.

Some plant housing systems already exist that are both self-watering and have covers to protect the plant but most are rather complex, either to manufacture, or to assemble or maintain by the user.

From prior art one should refer to the following documents:
CA2573216, disclosing a plant growth chamber has a housing having an interior and shelves for holding plants; a humidity chamber for injecting humidity into incoming air; vents directing the humidified air into the interior of the housing; and a light system within the housing. The light system is a light in an enclosed tube, and the enclosed tube has a separate air system for dissipating heat generated by the light,
NL1020694, disclosing how creation of a micro-climate around a growing organism in a greenhouse cultivation provides absolute energy economy and positive cultivation manipulation forth increase of production, flower formation or plant morphology, making use of the principle of an inverted temperature gradient. An adjustment is made of a buffering of the heat in the growing organism, so as to prevent radiation to the colder space in the upper part of the greenhouse as much as possible,
WO1998004231, relating to a plant cultivation method and a greenhouse or other cultivation space intended for it, and
WO2000057688, relating to a method for producing potato mini-tubers in the artificial climate of a cultivation apparatus, wherein during the plant growth process, a temperature gradient of 2 to 16° C. is created in the apparatus between the atmospheric stem area and the atmospheric root area.

### DISCLOSURE OF THE INVENTION

### Problems to be Solved by the Invention

As the plant grows, it can, with the passage of time, outgrow a protective housing system. Once the housing system is removed, the plant may however be adversely affected or may die due to hostile environmental factors such as temperature or difference in humidity from the environment within the plant housing system. The use of a plant housing system with suitable aperture addresses this problem and provides a solution by allowing the emerging new growth to adapt to the conditions prevailing outside the housing system. This is greatly facilitated by the fact that the majority bulk of the plant is still maintained at improved or optimal conditions within the housing system. As the new growth emerges from the plant housing system, it encounters such changes in humidity or temperature only gradually, thereby allowing the developing plant tissues the best chance to adapt to conditions external to the plant housing system.

Furthermore, as commonly found in agriculture and horticulture there is the problem of the growth of certain weeds or other unwanted plants which may grow around or in proximity to the wanted plant(s) and which hinder, impede and/or prevent the growth or productivity of the wanted plant(s). Removal/elimination of weeds can be a laborious and time consuming process. Use of weedicides/herbicides can be dangerous for any person or animal which may subsequently consume the plant. The use of a plant housing system addresses this problem and provides a solution by defining an exclusionary space around the plant which impedes and/or prevents the growth of weeds and other unwanted plants.

Therefore, a main objective of the present invention is to provide a plant housing that overcomes these problems.

### Means for Solving the Problems

The objective is achieved according to the invention by a plant housing as defined in the preamble of claim 1, having the features of the characterising portion of claim 1.

A number of non-exhaustive embodiments, variants or alternatives of the invention are defined by the dependent claims.

The present invention attains the above-described objective by a plant housing having a plant housing body being provided with means for setting up an environmental gradient. Such means can comprise at least one aperture, wherein the plant will adapt to the surrounding environment in the time it takes to grow past said aperture. The environmental gradient can be a temperature gradient and/or a humidity gradient.

### Effects of the Invention

The technical differences over prior art is that an environmental gradient above ground is set up by the plant housing, wherein the inside environment is suited for a young plant. As the plant gets older it grows and becomes hardier, and grows past the aperture in the housing when it is sufficiently hardy to withstand the harsher environments outside the plant housing.

Thus the housing is adapted to the height at which point the plant is deemed to be sufficiently hardy and the opening is adapted to set up a gradient that accommodates the plant growth requirements.

These effects provide in turn several further advantageous effects:
it makes it possible to grow plants outside their normal habitat
it avoids the problems with hothouses such as cost, humidity, cramped working conditions and pest control problems
it makes it possible to grow the plants in situ and without having to remove plant housings as known from prior art

### BRIEF DESCRIPTION OF THE DRAWINGS

The above and further features of the invention are set forth with particularity in the appended claims and together with advantages thereof will become clearer from consideration of the following detailed description of an exemplary embodiment of the invention given with reference to the accompanying drawings.

The invention will be further described below in connection with exemplary embodiments which are schematically shown in the drawings, wherein:

FIG. 1 shows a cross section of a plant housing

FIG. 2 shows a cross section of a plant housing with a water reservoir

FIG. 3 shows a cross section of a plant housing of FIG. 2 in perspective

FIG. 4 shows a photographic perspective view of a plant housing for decorative use

### DESCRIPTION OF THE REFERENCE SIGNS

The following reference numbers and signs refer to the drawings:

| Reference | Item |
|---|---|
| 100, 200, 300 | Plant housing |
| 102, 211, 311 | Plant housing body |
| 104, 213, 312 | Aperture, hole |
| 210, 310 | Water reservoir |
| 212, 312 | Horizontal plate, or platform or floor |

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The invention will be further described in connection with exemplary embodiments which are schematically shown in the drawings, wherein FIG. 1 shows a cross section of an embodiment of a plant housing according to the invention.

### PRINCIPLES FORMING THE BASIS OF THE INVENTION

The underlying principle of the invention is that an aperture in a plant housing will set up a temperature and/or humidity gradient that smoothly changes from the bottom of the plant housing, through the aperture itself and into the surrounding environment having an ambient temperature and humidity.

The gradients depend substantially on the differences between the conditions at the bottom of the interior of the plant housing and the ambient conditions, as well as the height of the aperture above the base of the plant housing and to some extent on the size of the aperture. The size should not be so large as to completely ventilate the plant housing and thus practically eliminate the gradient, nor should it be so small as to choke the plant as it grows past the aperture.

### BEST MODES OF CARRYING OUT THE INVENTION

As shown in FIG. 1, this invention relates to an adaptive plant housing system 100 having a plant housing body 102 with an opening or aperture 104 for plants, characterized in that the system provides for differentiated ambient temperature and/or humidly from an optimal temperature(s) or humidities most suited to growth of the plant from an area approximately most distant from an opening within the housing through to a temperature and/or humidity equivalent or close to the temperature and/or humidity of the environment surrounding the housing for the growing plant as it exits from the housing through said opening. The said plant housing system is adapted to be anchored in the ground or other stratum or substratum in which the plant or seedling or seed is planted to grow. The said plant housing system may contain a floor either permanently or removably attached to the wall of the plant housing system and containing one or more apertures or openings through which the plant or seed or seedling is brought into contact with the ground or if first planted, over the area where the seedling is expected to germinate the aperture or opening may be placed.

Suitable temperature and/or humidity is maintained around the plant by means of the wall of the said plant housing system (102) which will incorporate one or more apertures or openings at a position or positions in the said wall for optimising temperature and/or humidity and/or providing ventilation/watering (104). The said aperture(s) also allows new growth on plants to emerge and adapt to grow outside the plant housing system if ambient conditions permit. The watering may also be achieved by separate means connected to or removably or permanently attached fastened to or affixed to the said plant housing system.

The wall of the plant housing system (102) defines an exclusionary space for weeds and other plants. The dimensions of the housing system and associated aperture will be defined by the temperature and humidity requirements to provide improved or optimal conditions for growth of the specific type of plant to be housed.

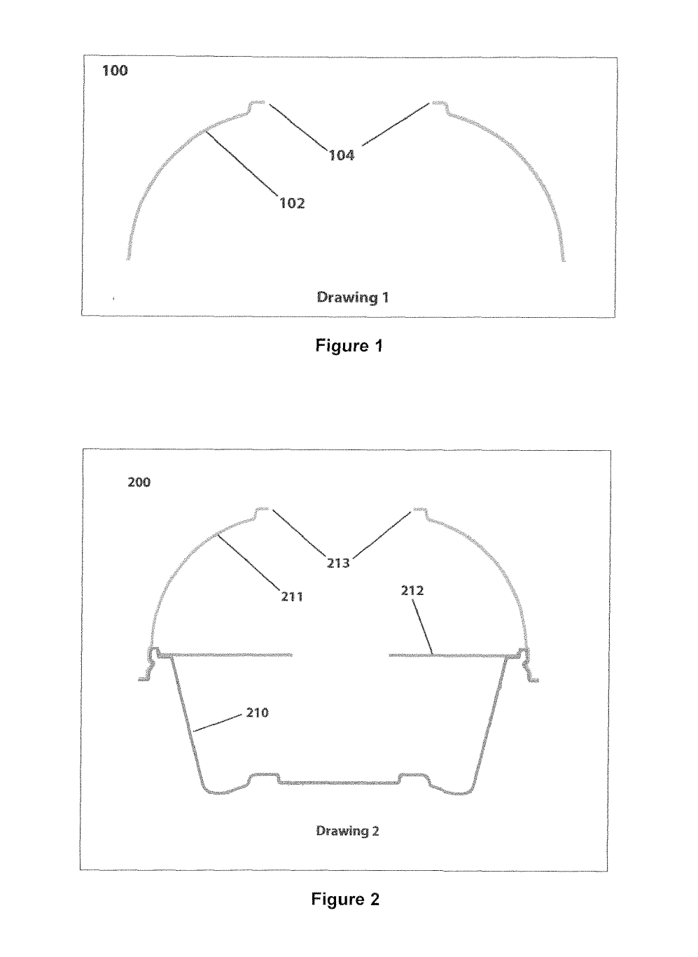

It is a purpose of one embodiment of this invention, as depicted in FIG. 2, to enable or facilitate the easy cultivation of tender ornamental plants which require high humidity, in a wide range of indoor and outdoor environments and various climatic conditions, with minimal maintenance. In this preferred embodiment, the plant housing system 211 is combined with a second liquid containing receptacle (210) and a horizontal platform or floor 212. The platform or floor incorporates a moulded pot or container or a separate container can be inserted into it, in which growing medium and the plant are placed. Liquid can be provided to the containing receptacle and the surface of the pot or container can have holes to enable the roots of the plant to intake moisture either by direct contact with the liquid or by means of the capillary action of strips of liquid conducting material removably or permanently attached to the pot or placed in the growing medium placed therein.

In one embodiment, the platform or floor may be cut out of flat plastic sheet, 212 as in the example of FIG. 2. This sheet has an aperture into which a pot or other container containing growing media is inserted. This platform or floor holds the pot upright and serves to isolate the growing portion of the plant housing system from the water reservoir.

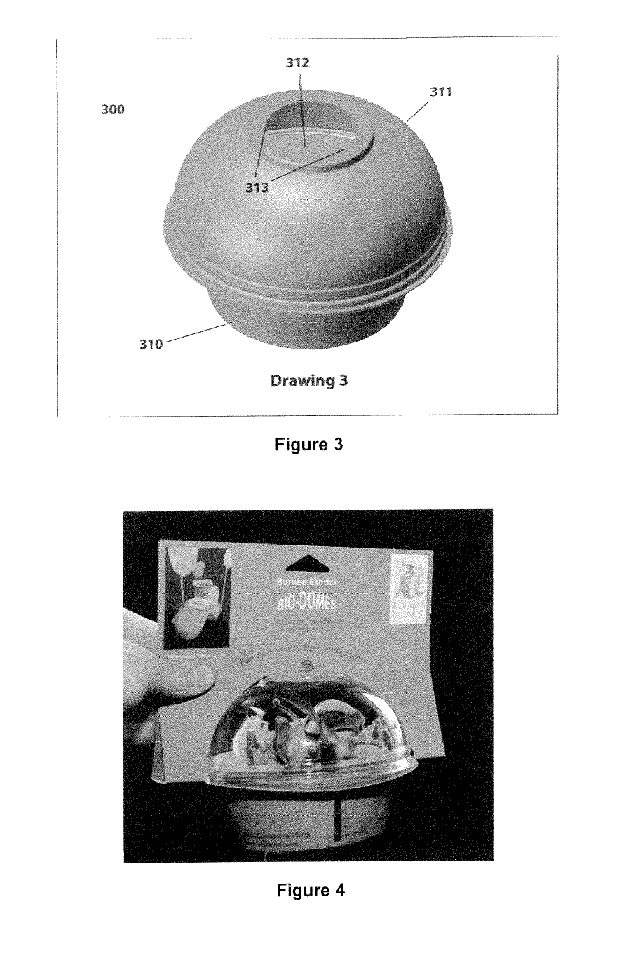

In another embodiment, the water reservoir and plant growing system cover are vacuum formed out of thin plastic (in the range of about 0.25-1.2 mm) and are much cheaper to manufacture and use less raw materials than injection moulded components. These are shown as 210 and 211 in FIGS. 2 and 310 and 311 in FIG. 3.

The aperture 213 in FIGS. 1 and 313 in FIG. 3 facilitates new growth on the plant to emerge through the aperture in the plant growing system and gives new leaves and shoots the chance to adapt to conditions which may otherwise prove lethally hostile if the plant were not acclimatised slowly through such means. The temperature and humidity differentiations which occur within the housing system which facilitate or bring about this adapting effect have been tested successfully with tender ornamentals, including Orchids and young plants of the genus Nepenthes, which are renowned to be exceedingly difficult plants to grow.

Plants can be left to grow in this system for at least one year with only occasional watering to replenish the water reservoir and sufficient light to sustain growth for the plant type under cultivation.

In another embodiment of the invention, the plant housing system disclosed herein may be produced as multiple reproductions in strips or layers or rolls or any other manner which permits large scale deployment in agriculture or horticulture.

Amongst the advantages of the present invention are that it discloses a plant housing system that is cheap to manufacture and, in so far as the first preferred embodiment is concerned, allows for ease of assembly in as much as the plant can be mounted and the unit assembled in just a few seconds since there are only 3 components and one simple clipping mechanism holds everything together. No parts are bonded by glues or any other bonding or folding process. The said plant housing system may be removable or integrally connected to a hanger or contains a hanging element. FIG. 4 shows the said plant housing system with a hanging element incorporated into the system.

Another advantage of the preferred embodiment is the ease with which watering of the plant may take place in as much as the reservoir may be replenished approximately once per month by simply by pouring through the hole in the dome lid cover where it then percolates down to the reservoir by filtering through the plant potting media. This has the following advantages over other systems:
a) The water filters through the potting media when poured into the top of the unit and ensures that any previously dry zones in the media that have formed since the last watering are rewetted at that time. This aids uniform water distribution through the potting media when subsequent capillary watering action is in effect.
b) The water reservoir is not open to the outside at any place or at any time in the watering process. Therefore, it is not possible for mosquitoes or other harmful flying insects to access the water reservoir and breed.
c) No component (such as a cap) has to be removed and replaced during the watering process.

A further advantage is ease of cleaning in as much as the whole unit can be disassembled in less than 5 seconds by unclipping the dome lid and lifting out the plant with its mounting plate (or platform or floor) for ease of cleaning of the water reservoir by the customer if unsightly algae forms or debris from the plant media accumulates.

The best known mode of operation of the plant housing system is that the plant housing system is attached or anchored or affixed whether permanently or removably to the ground or substrate and that plant or seed or seedling is planted in the substrate or ground and is provided with a route to germinate and or grow in the space defined by the walls and the said plant housing system is placed on or affixed to the ground and/or substrate.

The best known mode of operation of the invention as disclosed in the preferred embodiment is that water is supplied to the plant either by a simple wicking system hanging from the plant pot, or by inserting pot or growing media fully into the bottom of the water reservoir. The reservoir holds water sufficient for several weeks use by the plant without replenishment.

### ALTERNATIVE EMBODIMENTS

A number of variations on the above can be envisaged. For instance once can mechanically place such units in the field during the process of planting.

While the embodiments shown here are single unit of a roughly spherical form, it is also within the ambit of the invention to use elongated units, for instance formed by mechanically forming strips of plastic in the fields into plant housing systems having a gradient, apertures. Such plants can also grow through said apertures. Such plant housings may not have to be removed until or after harvesting, possibly as part of the harvesting process, and reused for next season.

The plant housing can also be provided with sun shields and/or reflectors for better adaption to region, such as shielding against noon sun or gathering extra light in morning and afternoon. Diffusive elements can be provided to diffuse light uniformly. Dark shields can also be used to absorb heat without illuminating the plant or to radiate heat away from the plant housing.

Gradient can be designed to provide a warm humid interior, tapering off to a cooler dryer ambient environment. Also this invention can be used in deserts where temperature must be kept cool and roots protected from drying out until the plant has grown deep roots and can withstand the hot, dry environment. Sun shields can be particularly useful in such situations.

The aperture can also be provided with means for preventing excessive ventilation due to wind or draft, such as providing the aperture with a shield, an edge, a serrated edge, bristle like structures or the like.

INDUSTRIAL APPLICABILITY

The invention according to the application finds use in plant growth both for home use as well as large scale industrial agriculture and/or horticulture.

1-11. (canceled)

12. A terrarium, comprising:
a reservoir for retaining water;
a mounting plate, supported above the reservoir, comprising a mounting plate aperture adapted to hold a pot; and
a dome, supported above the mounting plate, comprising a dome aperture substantially vertically aligned with the mounting plate aperture, wherein the dome aperture and dome establish and maintain an environmental gradient within the terrarium.

13. The terrarium of claim 12, wherein the reservoir has a non-round plan form with a flat bottom to maintain the plant in a vertical position.

14. The terrarium of claim 12, wherein the dome has a plurality of dome apertures.

15. The terrarium of claim 14, further comprising a dome having a plurality of dome apertures adapted to percolate and distribute water uniformly from the plurality of dome apertures into a potting media.

16. The terrarium of claim 12, wherein the dome has a plurality of dome apertures that are suitably sized to allow a seedling or young plant to germinate through any of the plurality of dome apertures.

17. The terrarium of claim 12, wherein the reservoir is substantially closed to an outside environment, preventing the ingress of pathogens or insects from breeding therein.

18. The terrarium of claim 16, further comprising reflective, diffusive, translucent, or heat absorbing elements adapted to promote gradients of warm humid air to relative cooler drier air in fluid communication with the suitably sized mounting plate aperture capable of uniformly distributing water and ventilating an interior region of the terrarium from the reservoir to the dome aperture.

19. The terrarium of claim 12, further comprising at least one funnel removably coupled with the dome, wherein the funnel is adapted to deliver liquid to a target area within the terrarium.

20. The terrarium of claim 12, wherein the dome aperture comprises approximately ⅙ to approximately ⅓ an area of an area of the mounting plate.

21. The terrarium of claim 12, wherein the dome is adapted to be assembled and disassembled with the reservoir and the mounting plate.

22. The terrarium of claim 12, wherein the mounting plate aperture is adapted for a plant to grow through.

23. The terrarium of claim 12, further comprising a pot bottom having inner vertical walls adapted to maintain a location of the plant in conjunction with the mounting plate and the mounting plate aperture.

24. The terrarium of claim 12, wherein the mounting plate has a mounting plate aperture adapted to hold a pot or plug of growing media aligned with the dome aperture and maintains the pot or plug of growing media in water in the reservoir.

25. The terrarium of claim 12, wherein the environmental gradient is at least one of temperature or relative humidity.

26. The terrarium of claim 12, wherein the reservoir comprises an inner shelf adapted for locating the mounting plate between the reservoir and the dome.

27. The terrarium of claim 12, wherein the dome comprises at least one arcuate surface terminated in the dome aperture.

28. A terrarium, comprising:
a reservoir for retaining water, having inner discontinuous vertical walls for maintaining a location of a plant and having an inner horizontal shelf;
a mounting plate, supported above the reservoir on the inner horizontal shelf, comprising at least one mounting plate aperture adapted to hold a pot or a plug of growing media; and
a dome, supported above the mounting plate, comprising a dome aperture substantially vertically aligned with the at least one mounting plate aperture, wherein the dome aperture and dome in conjunction with the at least one mounting plate aperture and at least one of reflective, diffusive, translucent, or heat absorbing elements, which are adapted to promote gradients of warm humid air to relative cooler drier air in fluid communication with the at least one mounting plate aperture, establish and maintain an environmental gradient within the terrarium, wherein the dome is adapted to be assembled and disassembled with the mounting plate and reservoir and the mounting plate aperture is adapted to hold a pot or a plug of growing media.

29. A terrarium for cultivating difficult to grow plants, comprising:
a plant housing body comprising,
a reservoir for holding a liquid;
a transparent or translucent lid adapted to cover the reservoir and having at least one lid aperture, the lid having a height approximately twice that of a height of the reservoir;
a mounting plate having a mounting plate aperture disposed between the reservoir and the lid, and
a difficult to cultivate seedling or young plant, wherein the height of the lid and the size of the at least one lid aperture permits at least one of a humidity or temperature gradient to form from a bottom of the reservoir to the at least one lid aperture, thereby allowing the difficult to cultivate seedling or young plant to adapt to a surrounding environment.

30. The terrarium of claim 29, wherein the difficult to cultivate seedling or young plant is one of a Nepenthes plant or an orchid.

31. The terrarium of claim 29, wherein the difficult to cultivate seedling or young plant grows through the lid aperture, subjecting the difficult to cultivate seedling or young plant to the humidity or temperature gradient within the terrarium, allowing the difficult to cultivate seedling or young plant to become gradually acclimated to the environment surrounding the terrarium.
